(19) United States
(12) Patent Application Publication
(10) Pub. No.: US 2018/0244112 A1
(43) Pub. Date: Aug. 30, 2018

(54) Pneumatic Tire

(71) Applicant: The Yokohama Rubber Co., LTD., Minato-ku, Tokyo (JP)

(72) Inventors: Tomoyuki Sakai, Hiratsuka-Shi, Kanagawa (JP); Hidekazu Onoi, Hiratsuka-Shi, Kanagawa (JP)

(21) Appl. No.: 15/553,962

(22) PCT Filed: Feb. 24, 2016
(86) PCT No.: PCT/JP2016/055415

§ 371 Date: Aug. 31, 2017

(30) Foreign Application Priority Data
Feb. 27, 2015 (JP) 2015-037566

(51) Int. Cl. B60C 13/00; B60C 1/00; C08L 9/00; C08J 9/00; C08J 9/10; C09K 5/14

(52) U.S. Cl. CPC B60C 13/00; B60C 1/0025; C08L 9/00; C08J 9/0061; C08J 9/0066; C08J 9/107; C08J 2203/04; C09K 5/14; B60C 2013/006; C08L 2205/03; C08J 2309/00; C08J 2307/00; C08J 9/101

(57) ABSTRACT

Provided is a pneumatic tire which comprises a pair of left and right bead portions, sidewall portions continuous from the bead portions, and a tread portion that couples the sidewall portions. The pneumatic tire has a carcass layer mounted between the left and right bead portions. The sidewall portions each have a foamed rubber layer disposed outside the carcass layer and a side rubber layer disposed outside the foamed rubber layer. The density of the foamed rubber layer is from 0.5 to 0.9 g/cm³ and a tan δ of the foamed rubber layer at 20° C. is not greater than 0.17. A rubber composition for sidewalls that forms the side rubber layer is obtained by blending from 1 to 20 parts by weight of a thermoplastic resin and from 10 to 65 parts by weight of a carbon black in 100 parts by weight of a diene rubber.

### TECHNICAL FIELD

The present technology relates to a pneumatic tire that allows rolling resistance to be reduced while ensuring external damage resistance at sidewall portions.

### BACKGROUND ART

Improving fuel consumption rates of automobiles has been desired in recent years for reducing rolling resistance for pneumatic tires. Conventionally, reduction of rolling resistance has been pursued in pneumatic tires. There have been various proposals to reduce a weight of the tire in terms of structure and material. However, all of these proposals have both merits and demerits, and cannot sufficiently satisfy the reduction in the rolling resistance.

As an example of the proposals, formation of sidewall portions from a specific foamed rubber layer has been proposed (see Japanese Patent No. 5252091). However, when the sidewall portions are formed from the foamed rubber layer, there is a problem in that the external damage resistance is deteriorated during collision with a curbstone or the like. Therefore, a reduction in rolling resistance to or beyond conventional levels while ensuring external damage resistance at sidewall portions is required.

### SUMMARY

The present technology provides a pneumatic tire which allows rolling resistance to be reduced while ensuring external damage resistance at sidewall portions.

The pneumatic tire of the present technology for achieving the aforementioned object comprises a pair of left and right bead portions, sidewall portions continuous from the bead portions, and a tread portion that couples the sidewall portions. The pneumatic tire has a carcass layer mounted between the left and right bead portions. In the pneumatic tire, the sidewall portions each having a foamed rubber layer disposed outside the carcass layer and a side rubber layer disposed outside the foamed rubber layer; the density of the foamed rubber layer is from 0.5 to 0.9 g/cm³ and a tan δ of the foamed rubber layer at 20° C. is not greater than 0.17; and a rubber composition for sidewalls that forms the side rubber layer is obtained by blending from 1 to 20 parts by weight of a thermoplastic resin and from 10 to 65 parts by weight of a carbon black in 100 parts by weight of a diene rubber.

According to the pneumatic tire of the present technology, the sidewall portions are formed by laminating a side rubber layer on the foamed rubber layer. The foamed rubber layer has a density of from 0.5 to 0.9 g/cm³ and a tan δ at 20° C. is not greater than 0.17. The rubber composition for sidewalls that forms the side rubber layer is obtained by blending from 1 to 20 parts by weight of a thermoplastic resin and from 10 to 65 parts by weight of a carbon black in 100 parts by weight of a diene rubber. Therefore, rolling resistance can be reduced while ensuring the external damage resistance at sidewall portions.

The ratio of the volume of the foamed rubber layer to that of the side rubber layer (foamed rubber layer/side rubber layer) may be from 1/1 to 10/1. The rubber composition for sidewalls may include a polystyrene and/or a polypropylene as the thermoplastic resin. 100 wt. % of the diene rubber may contain from 30 to 70 wt. % of natural rubber and from 70 to 30 wt. % of butadiene rubber and/or styrene butadiene rubber.

The thermal conductivity of the foamed rubber layer may be from 0.05 to 0.2 W/mk. Further, the foamable rubber composition forming the foamed rubber layer may contain a nitroso foaming agent and/or an azo foaming agent. Further, the foamable rubber composition may include from 0.1 to 20 parts by weight of urea in 100 parts by weight of the diene rubber.

### BRIEF DESCRIPTION OF DRAWINGS

FIG. 1 is a half cross-sectional view illustrating an example of a pneumatic tire according to an embodiment of the present technology.

### DETAILED DESCRIPTION

The configuration of the present technology will now be described in detail with reference to the accompanying drawings. In the present technology, the term sidewall portion refers to a “portion between the tread and the bead” defined in JATMA (Japan Automobile Tyre Manufacturers Association, Inc.) Safety Standards for Automobile Tires.

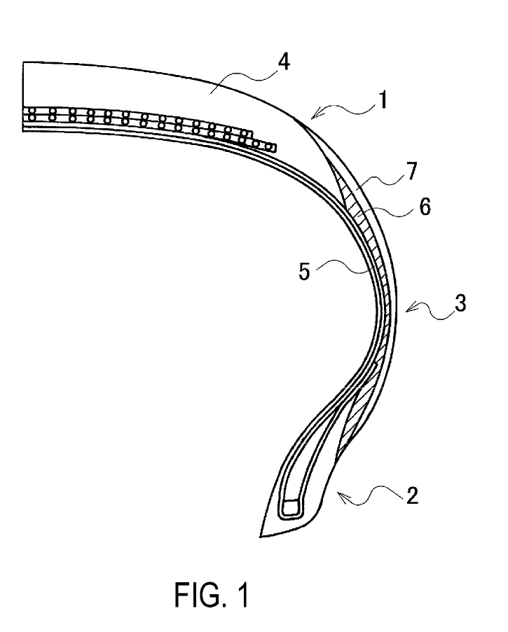

In FIG. 1, the pneumatic tire 1 of the present technology is provided with a pair of left and right bead portions 2 and 2, sidewall portions 3 and 3 continuous from the bead portions 2 and 2, and a tread portion 4 that couples the sidewall portions 3 and 3, and a carcass layer 5 is mounted between the left and right bead portions 2 and 2.

In the present technology, the foamed rubber layer 6 is disposed outside the carcass layer 5 at the sidewall portion 3, and the side rubber layer 7 is disposed outside the foamed rubber layer 6. The foamed rubber layer 6 is molded from a foamable rubber composition, and the side rubber layer 7 is molded from a rubber composition for sidewalls. The foamed rubber layer 6 forming the pneumatic tire of the present technology has a density of from 0.5 to 0.9 g/cm³ and a tan δ at 20° C. of not greater than 0.17. The rubber composition for sidewalls contains from 1 to 20 parts by weight of a thermoplastic resin and from 10 to 65 parts by weight of a carbon black in 100 parts by weight of a diene rubber.

In the rubber composition for sidewalls, a rubber component is a diene rubber. Examples of the diene rubber include a natural rubber, an isoprene rubber, a butadiene rubber, a styrene butadiene rubber, a butyl rubber, an ethylene propylene diene rubber, a chloroprene rubber, and the like. Of these, a natural rubber, a butadiene rubber, and a styrene butadiene rubber are preferable. These diene rubbers may be used singly or in combination thereof.

The rubber composition for sidewalls preferably contains from 30 to 70 wt. % of natural rubber and from 70 to 30 wt. % of butadiene rubber and/or styrene butadiene rubber in 100 wt. % of the diene rubber. When the content of the natural rubber is less than 30 wt. % and the content of the butadiene rubber and styrene butadiene rubber exceeds 70 wt. %, the external damage resistance is deteriorated. When the content of the natural rubber exceeds 70 wt. % and the content of the butadiene rubber and styrene butadiene rubber is less than 30 wt. %, the flexural fatigue is deteriorated. The content of the natural rubber is more preferably from 35 to 60 wt. %, and the content of the butadiene rubber and/or the styrene butadiene rubber is more preferably from 40 to 65 wt. %.

In the present technology, blending of the thermoplastic resin can enhance the rigidity of the rubber composition for sidewalls and improve the external damage resistance. The blending amount of the thermoplastic resin is from 1 to 20 parts by weight, and preferably from 2 to 15 parts by weight in 100 parts by weight of the diene rubber. When the blending amount of the thermoplastic resin is less than 1 parts by weight, an effect of improving the external damage resistance cannot be obtained. When the blending amount of the thermoplastic resin exceeds 20 parts by weight, energy loss of compression set and rubber distortion deformation increases. Therefore, the rubber composition for sidewalls unfavorably becomes plastic.

Examples of the thermoplastic resin include polyolefin resins, polystyrene resins, polyester resins, polyamide resins, polyvinyl alcohol resins, polyacrylonitrile resins, polyacrylic acid resins, polyether resins, polycarbonate resins, polyurethane resins, and the like. The thermoplastic resin may be a homopolymer, a block copolymer, or a random copolymer. Of these, a polystyrene, a polypropylene, and a polyethylene are preferable, and a polystyrene and a polypropylene are more preferable. Polypropylene may be any of a homopolypropylene, a random polypropylene, and a block polypropylene. The random polypropylene and the block polypropylene may contain am α-olefin having 4 or more carbon atoms such as 1-butene, in addition to ethylene.

In the rubber composition for sidewalls, the blending amount of the carbon black is from 10 to 65 parts by weight, and preferably from 20 to 60 parts by weight in 100 parts by weight of the diene rubber. When the blending amount of the carbon black is less than 10 parts by weight, the hardness and rigidity of the rubber composition are insufficient, and the effect of improving the external damage resistance cannot be obtained. When the blending amount of the carbon black exceeds 65 parts by weight, the elongation at break decreases, and the flexural fatigue resistance due to repeated deformation also deteriorates.

A tensile stress at which a strip-shaped sheet of 50×10×2 of the rubber composition for sidewalls is deformed by 10% at 20° C. in a tensile mode (hereinafter referred to as ‘tensile stress of 10%’) may be preferably not less than 4.5 MPa, and more preferably from 5 to 15 MPa. Setting the tensile stress of 10% of the rubber composition for sidewalls to not less than 4.5 MPa may further improve external damage resistance. The tensile stress of the rubber composition for sidewalls can be adjusted depending on the type and blending amount of the thermoplastic resin, the blending amount of the carbon black, and the like. In the present specification, the tensile stress of the rubber composition for sidewalls is measured under vibration conditions of a preliminarily strain of 10%±10%, 20 Hz, and 20° C. in accordance with JIS (Japanese Industrial Standard) K7244-4.

The foamed rubber layer 6 forming the sidewalls has a density of from 0.5 to 0.9 g/cm³ and a tan δ at 20° C. of not greater than 0.17. Therefore, the weight of the tire can be reduced due to disposal of the foamed rubber layer 6, and the rolling resistance can be reduced at a temperature at which the tan δ is small due to insulation and accumulation of heat generated during running of the tire by the foamed rubber layer 6.

The density of the foamed rubber layer 6 is from 0.5 to 0.9 g/cm³, and preferably from 0.6 to 0.9 g/cm³. When the density of the foamed rubber layer 6 is less than 0.5 g/cm³, it is difficult to secure the cracking resistance at the sidewall portions 3. When the density of the foamed rubber layer 6 exceeds 0.9 g/cm³, thermal insulation and thermal accumulation by the foamed rubber layer 6 becomes difficult, and an effect of reducing the rolling resistance is insufficient. Further, the weight of the foamed rubber layer cannot be sufficiently reduced. The density of the foamed rubber layer 6 is measured at 20° C. in accordance with JIS K6268. In the case of a foamed rubber, which has small specific gravity, a weight is appropriately attached so that the foam rubber does not float, and the measurement is carried out. The density of the foamed rubber layer 6 can be adjusted by an expansion ratio.

The tan δ at 20° C. of the foamed rubber layer 6 is not greater than 0.17, and preferably from 0.15 to 0.05. When the tan δ at 20° C. of the foamed rubber layer 6 exceeds 0.17, the effect of reducing the rolling resistance is not sufficiently obtained. The tan δ at 20° C. of the foamed rubber layer 6 is measured at 20° C. in a tensile deformation mode in which a strip-shaped sheet of 50×10×2 is vibrated at 20 Hz in a tensile mode in accordance with JIS K7244-6. The tan δ at 20° C. of the foamed rubber layer 6 can be adjusted by the amount of a foaming agent and a vulcanization time.

The thermal conductivity of the foamed rubber layer 6 may be preferably from 0.05 to 0.20 W/mK, and more preferably from 0.07 to 0.18 W/mK. When the thermal conductivity of the foamed rubber layer 6 is less than 0.05 W/mK, it is necessary to increase the expansion ratio. This is advantageous in terms of reducing the weight of the tire, but it is difficult to ensure the external damage resistance of the sidewall portions 3. When the thermal conductivity exceeds 0.20 W/mK, heat generated during running of the tire is easily conducted. Due to the heat radiation effect, it is difficult to reduce the rolling resistance of the foamed rubber layer. In the present technology, the thermal conductivity of the foamed rubber layer is measured in accordance with IS08301 (International Organization for Standardization, standard 8301). The thermal conductivity can be adjusted by selecting the rubber component in the rubber composition forming the foamed rubber layer 6 and the foaming agent and the foaming aid which are blended in the rubber component.

In the present technology, the ratio of the volume of the foamed rubber layer to that of the side rubber layer (foamed rubber layer/side rubber layer) may be preferably from 1/1 to 10/1, and more preferably from 2/1 to 10/1. When the volume ratio (foamed rubber layer/side rubber layer) is 1/1 or greater, the rolling resistance can be reduced, and the weight of the tire can be reduced. When the volume ratio (foamed rubber layer/side rubber layer) is 10/1 or less, the external damage resistance of the side rubber layer can be surely secured.

In the pneumatic tire of the present technology, the specific gravity of the sidewall portions comprising the foamed rubber layer and the side rubber layer may be preferably from 0.55 to 0.95 g/cm³ and more preferably 0.60 to 0.90 g/cm³.

The foamed rubber layer 6 is formed from the foamable rubber composition. The foamable rubber composition can be prepared by blending a foaming agent, a foaming aid, and the like into a usual rubber composition for tire sidewalls. Therefore, the rubber composition for sidewalls used in the present technology may include the foaming agent, the foaming aid, and the like, instead of the thermoplastic resin. In consideration of values of density and tan δ at 20° C., the composition of the foamable rubber composition may be designed so as to be different from the basic composition of the rubber composition for sidewalls.

Examples of the rubber component in the foamable rubber composition that can be used preferably include a natural rubber, a diene rubber such as an isoprene rubber, a butadiene rubber, or a styrene butadiene rubber, or an olefin rubber such as an ethylene propylene rubber. These rubber components may be used alone or in any combination thereof. Of these, natural rubber and butadiene rubber are preferably contained, and in particular, natural rubber is preferable. In 100 wt. % of the rubber component, the natural rubber may be contained preferably in an amount 20 wt. % or greater, and more preferably from 30 to 100 wt. %. When the content of the natural rubber falls within this range, the rubber strength of the foamed rubber layer can be enhanced.

The foamable rubber composition may include a chemical foaming agent in an amount of preferably from 0.1 to 20 parts by weight, and more preferably from 1.0 to 15 parts by weight in 100 parts by weight of the diene rubber. When the blending amount of the chemical foaming agent is less than 0.1 parts by weight, foaming during vulcanizing becomes insufficient, and the expansion ratio cannot be increased. When the blending amount of the chemical foaming agent exceeds 20 parts by weight, an effect of increasing the expansion ratio reaches its peak despite the increase in cost.

Examples of the chemical foaming agent include a nitroso foaming agent, an azo foaming agent, a carbon diamide foaming agent, a sulfonyl hydrazide foaming agent, and an azide foaming agent. Of these, the nitroso foaming agent and/or the azo foaming agent are preferable. The chemical foaming agent may be used alone or in a mixture of two or more.

Examples of the nitroso foaming agent include N,N′-dinitroso-pentamethylene tetramine (DPT), N,N′-dimethyl-N,N′-dinitroso-terephthalamide, and the like. Examples of the azo foaming agent include azobisisobutyronitrile (AZBN), azobiscyclohexylnitrile, azodiaminobenzene, bariumazodicarboxylate, and the like. Examples of the carbon diamide foaming agent include azodicarbonamide (ADCA) and the like. Examples of the sulfonyl hydrazide foaming agent include benzenesulfonylhydrazide (BSH), p,p′-oxybis(benzenesulfonylhydrazide)(OBSH), toluenesulfonylhydrazide (TSH), and diphenylsulfone-3,3′-disulfonylhydrazide, and the like. Examples of the azide foaming agent include calcium azide, 4,4′-diphenyldisulfonylazide, p-toluenesulfonylazide, and the like.

The decomposition temperature of the chemical foaming agent is preferably from 130° C. to 190° C., and more preferably from 150° C. to 170° C. Controlling the decomposition temperature of the chemical foaming agent within this range facilitates chemical foaming and vulcanization control. In the present specification, the decomposition temperature of the chemical foaming agent is a temperature determined by measuring decomposition heat and weight decrease using a heat analysis method selected from differential scanning calorimetry (DSC) and thermogravimetry (TGA).

The foamable rubber composition may contain urea with the chemical foaming agent. The urea acts as a foaming aid. When the urea foaming aid is blended, the temperature at which the chemical foaming agent is thermally decomposed is adjusted to be low. Thus, the foaming aid can be efficiently thermally decomposed. The blending amount of the urea foaming aid is preferably from 0.1 to 20 parts by weight, and more preferably from 0.5 to 10 parts by weight, in 100 parts by weight of the diene rubber. When the blending amount of the urea foaming aid is less than 0.1 parts by weight, the thermal decomposition temperature of the chemical foaming agent cannot be sufficiently adjusted. The blending amount of the urea foaming aid is preferably from 0.5 to 1.5 times the amount of the chemical foaming agent to be blended. When the amount is less than 0.5 times, an effect acting as an aid is not obtained. When the amount is greater than 1.5 times, the urea foaming aid does not react and remains as a foreign substance in the composition, to reduce the mechanical strength.

In the present technology, blending a filler may increase the rubber strength of the foamable rubber composition. The blending amount of the filler is preferably from 20 to 100 parts by weight, and more preferably from 40 to 80 parts by weight, in 100 parts by weight of the diene rubber. When the blending amount of the filler is less than 20 parts by weight, the rubber strength of the foamable rubber composition cannot be sufficiently increased. When the blending amount of the filler exceeds 100 parts by weight, processability of the foamable rubber composition is reduced.

Examples of the filler include carbon black, silica, calcium carbonate, clay, mica, diatomaceous earth, talc, and the like. Of these, carbon black, silica, and calcium carbonate are preferable. The fillers may be used alone or in any combination thereof.

To the foamable rubber composition, a compounding agent typically used in an industrial-use rubber composition or a rubber foam, such as a vulcanizing agent, a vulcanization accelerator, a vulcanization aid, a rubber reinforcing agent, a softener (plasticizer), an anti-aging agent, a processing aid, a foaming aid, a defoaming agent, an activator, a mold release agent, a heat resistant stabilizer, a weather resistant stabilizer, an antistatic agent, a colorant, a lubricant, or a thickening agent can be added. The amounts of these compounding agents may also be made to be generally compounded amounts as long as the object of the present technology is not impaired. The compounding agents can be added, kneaded, or mixed according to a common preparation method.

The present technology will be further described below with reference to Examples. However, the scope of the present technology is not limited to these Examples.

### Examples

### Preparation and Evaluation of the Rubber Composition for Sidewalls and the Foamable Rubber Composition

For five types of rubber compositions for sidewalls (formulations A to E) and four types of foamable rubber compositions (formulations F to I) of rubber compounding proportions shown in Table 1, each component except for the sulfur, the vulcanization accelerator, and the chemical foaming agent was weighed. The components were kneaded in a 1.7-L sealed Banbury Mixer for 5 minutes. A master batch was discharged at a temperature of 150° C. and cooled at room temperature. The master batch was then subjected to a heating roll, and the sulfur, the vulcanization accelerator, and the chemical foaming agent were then added and mixed to prepare the rubber compositions for sidewalls and the foamable rubber compositions.

The obtained five types of rubber compositions for sidewalls (formulations A to E) were put into a mold having a predetermined shape (100 mm long and 100 mm wide), and press-vulcanized with heating at a temperature of 180° C. for 15 minutes to mold vulcanized test pieces. Using the resulting vulcanized test pieces, tensile stress of 10% was measured by the following method.

### Tensile Stress of 10%

The tensile stress during 10% deformation of the obtained vulcanized test pieces was measured using a spectrometer (manufactured by Toyo Seiki Seisaku-sho, Ltd.) under measurement conditions of a strain of 10%±10%, a frequency of 20 Hz, and 20° C. in accordance with JIS K7244-4. The obtained results are described in the column of “Tensile stress of 10%” of Table 1.

The obtained four types of foamable rubber compositions (formulations F to I) were each put into a mold having a predetermined shape (100 mm long and 100 mm wide), and press-vulcanized with heating at a temperature of 180° C. for 15 minutes. Vulcanization and foaming were carried out simultaneously to mold each foamed rubber molded body having a thickness of about 15 mm. Using the resulting foamed rubber molded bodies, the density, tan δ at 20° C., and thermal conductivity were measured by the following method.

### Density

The density of the foamed rubber molded body was measured at 20° C. in accordance with JIS K6268. In the case of foamed rubber, 2 g of iron weight whose volume was measured beforehand was hung, and the whole volume and weight were measured. The volume and weight were calculated by subtracting the volume and weight of the iron, and the density was calculated. The obtained results are described in the column of “Density” of Table 1. The specific gravity of the sidewall portion comprising the foamed rubber layer and the side rubber layer in the pneumatic tire was also measured in the same manner. The obtained results are described in the column of “Specific gravity of sidewall portion” of Table 2.

### Tan δ at 20° C.

The tan δ of the foamed rubber molded body was measured using a viscoelastic spectrometer manufactured by Toyo Seiki Seisaku-sho, Ltd., under the conditions of a strain of 10%±2%, a frequency of 20 Hz, and an atmospheric temperature of 20° C. The obtained results are described in the column of “tan δ (20° C.)” of Table 1.

### Thermal Conductivity

The thermal conductivity of the foamed rubber molded body was measured by a hot wire method using a quick thermal conductivity meter (QTM-500, manufactured by Kyoto Electronics Manufacturing Co., Ltd.) in accordance with IS08301. The obtained results are described in the column of “Thermal conductivity” of Table 1.

TABLE 1

| | | Rubber composition for sidewalls | | | | |
|---|---|---|---|---|---|---|
| | | Formu- | Formu- | Formu- | Formu- | Formu- |
| | | lation | lation | lation | lation | lation |
| | | A | B | C | D | E |
| NR | parts by | 40 | 40 | 40 | 40 | 40 |
| | weight | | | | | |
| BR | parts by | 60 | 60 | 60 | 60 | 60 |
| | weight | | | | | |
| Carbon black | parts by | 50 | 50 | 50 | 50 | 75 |
| | weight | | | | | |
| Zinc oxide | parts by | 3 | 3 | 3 | 3 | 3 |
| | weight | | | | | |
| Stearic acid | parts by | 2 | 2 | 2 | 2 | 2 |
| | weight | | | | | |
| Anti-aging | parts by | 3 | 3 | 3 | 3 | 3 |
| agent | weight | | | | | |
| Wax | parts by | 1 | 1 | 1 | 1 | 1 |
| | weight | | | | | |
| Oil | parts by | 20 | 20 | 20 | 20 | 20 |
| | weight | | | | | |
| PP | parts by | — | 8 | — | 12 | — |
| | weight | | | | | |
| PS | parts by | — | — | 8 | — | — |
| | weight | | | | | |
| Sulfur | parts by | 2 | 2 | 2 | 2 | 2 |
| | weight | | | | | |
| Vulcanization | parts by | 1 | 1 | 1 | 1 | 1 |
| accelerator | weight | | | | | |
| Chemical | parts by | — | — | — | — | — |
| foaming agent | weight | | | | | |
| Tensile | MPa | 2.56 | 7.02 | 6.51 | 13.20 | 4.08 |
| stress of 10% | | | | | | |
| Density | g/cm³ | — | — | — | — | — |
| tan δ (20° C.) | — | — | — | — | — | — |
| Thermal | W/mK | — | — | — | — | — |
| conductivity | | | | | | |

| | | Foamable rubber composition | | | |
|---|---|---|---|---|---|
| | | Formu- | Formu- | Formu- | Formu- |
| | | lation | lation | lation | lation |
| | | F | G | H | I |
| NR | parts by | 40 | 40 | 40 | 40 |
| | weight | | | | |
| BR | parts by | 60 | 60 | 60 | 60 |
| | weight | | | | |
| Carbon black | parts by | 50 | 50 | 5 | 100 |
| | weight | | | | |
| Zinc oxide | parts by | 3 | 3 | 3 | 3 |
| | weight | | | | |
| Stearic acid | parts by | 2 | 2 | 2 | 2 |
| | weight | | | | |
| Anti-aging | parts by | 3 | 3 | 3 | 3 |
| agent | weight | | | | |
| Wax | parts by | 1 | 1 | 1 | 1 |
| | weight | | | | |
| Oil | parts by | 20 | 20 | 20 | 20 |
| | weight | | | | |
| PP | parts by | — | — | — | — |
| | weight | | | | |
| PS | parts by | — | — | — | — |
| | weight | | | | |
| Sulfur | parts by | 2 | 2 | 2 | 2 |
| | weight | | | | |
| Vulcanization | parts by | 1 | 1 | 0.5 | 1 |
| accelerator | weight | | | | |
| Chemical foaming | parts by | 4 | 6 | 10 | 4 |
| agent | weight | | | | |
| Tensile | MPa | — | — | — | — |
| stress of 10% | | | | | |
| Density | g/cm³ | 0.741 | 0.612 | 0.325 | 1.15 |
| tan δ (20° C.) | — | 0.09 | 0.08 | 0.11 | 0.18 |
| Thermal | W/mK | 0.185 | 0.152 | 0.115 | 0.235 |
| conductivity | | | | | |

The types of raw materials used in Table 1 are shown below.
NR: Natural rubber, TSR20
BR: Butadiene rubber, Nipol BR1220 manufactured by Zeon Corporation
Carbon black: FEF grade carbon black, HTC-100 manufactured by Chubu Carbon
Zinc oxide: Zinc Oxide III manufactured by Seido Chemical Industry Co., Ltd.
Stearic acid: Beads Stearic Acid YR manufactured by NOF Corp.
Anti-aging agent: SANTOFLEX 6PPD manufactured by Flexsys
Wax: Paraffin wax
Oil: Aroma oil, A-OMIX manufactured by Sankyo Yuka Kogyo K.K.
PP: polypropylene, E-333GV manufactured by Prime Polymer
PS: polystyrene, MW1C manufactured by Toyo Styrene Co., Ltd.
Sulfur: GOLDEN FLOWER SULFUR POWDER 150 mesh manufactured by Tsurumi Chemical Industry Co., ltd.
Vulcanization accelerator: NOCCELER NS-P, manufactured by Ouchi Shinko Chemical Industrial Co., Ltd.
Chemical foaming agent: Nitroso foaming agent, Cellular CK#54 manufactured by Eiwa Chemical Ind. Co., Ltd.

### Production and Evaluation of Pneumatic Tire

12 types of pneumatic tires (Examples 1 to 5, Comparative Examples 1 to 5, and Standard Examples 1 and 2) were respectively produced such that the tire size was 195/65R15, the basic structure of the tires was one illustrated in FIG. 1, and the sidewall portions 3 are formed by laminating the rubber compositions for sidewalls and the foamable rubber compositions obtained as described above such that the average thickness thereof varied as shown in Table 2. Each of the obtained 12 types of tires was subjected to test methods described below to evaluate the rolling resistance and the external damage resistance. The results are shown in Table 2.

### Rolling Resistance

Each tire was assembled on a rim (size: 15×6J), and filled with air at an air pressure of 230 kPa. A rolling resistance value was measured using an indoor drum tester (drum diameter: 1707 mm) under conditions of a load of 4.5 kN and a speed of 80 km/h in accordance with JIS D 4234. The results are shown in the column of “Rolling resistance” of Table 2 as an index value with the inverse of the rolling resistance value of Standard Example 1 taken as 100. Higher index values indicate lower rolling resistance.

### External Damage Resistance

Each tire was assembled on a rim (size: 15×6J), and mounted on a vehicle with an engine displacement of 1800 cc. When the front wheel was collided with a concrete curbstone having a height of 20 cm at an invasion angle of 5°, the minimum speed at which the sidewall portion was damaged was measured. The results are described in the column of “External damage resistance” of Table 2 as an index value with the value of Standard Example 1 taken as 100. Higher index values indicate excellent external damage resistance.

TABLE 2

| | | | Standard | Standard | | |
|---|---|---|---|---|---|---|
| | | | Example 1 | Example 2 | Example 1 | Example 2 |
| Side | Type | — | Formulation | None | Formulation | Formulation |
| rubber | | | A | | B | C |
| layer | Thickness | mm | 2.5 | — | 0.5 | 0.5 |
| | Tensile stress | MPa | 2.56 | — | 7.02 | 6.51 |
| | of 10% | | | | | |
| Foamed | Type | — | None | Formulation | Formulation | Formulation |
| rubber | | | | F | F | F |
| layer | Thickness | mm | — | 2.5 | 2.0 | 2.0 |
| | Density | g/cm³ | — | 0.741 | 0.741 | 0.741 |
| | tan δ (20° C.) | — | — | 0.090 | 0.090 | 0.090 |
| | Thermal | W/mK | — | 0.185 | 0.185 | 0.185 |
| | Conductivity | | | | | |
| Specific gravity of | | g/cm³ | | | 0.805 | 0.805 |
| sidewall portion | | | | | | |
| Volume ratio (foamed | | | — | — | 4.0 | 4.0 |
| rubber/side rubber) | | | | | | |
| Rolling resistance | | Index | 100 | 108 | 107 | 107 |
| | | value | | | | |
| External damage | | Index | 100 | 95 | 104 | 103 |
| resistance | | value | | | | |
| | | | | | | Comparative |
| | | | Example 3 | Example 4 | Example 5 | Example 1 |
| Side | Type | — | Formulation | Formulation | Formulation | Formulation |
| rubber | | | B | B | D | A |
| layer | Thickness | mm | 0.5 | 1.0 | 0.3 | 0.5 |
| | Tensile stress | MPa | 7.02 | 7.02 | 13.20 | 7.02 |
| | of 10% | | | | | |
| Foamed | Type | — | Formulation | Formulation | Formulation | Formulation |
| rubber | | | G | F | F | F |
| layer | Thickness | mm | 2.0 | 1.5 | 1.2 | 2.0 |
| | Density | g/cm³ | 0.612 | 0.741 | 0.741 | 0.741 |
| | tan δ (20° C.) | — | 0.080 | 0.090 | 0.090 | 0.090 |
| | Thermal | W/mK | 0.152 | 0.185 | 0.185 | 0.185 |
| | Conductivity | | | | | |
| Specific gravity of | | g/cm³ | 0.702 | 0.869 | 0.805 | 0.805 |
| sidewall portion | | | | | | |
| Volume ratio (foamed | | | 4.0 | 1.5 | 4.0 | 4.0 |
| rubber/side rubber) | | | | | | |
| Rolling resistance | | Index | 110 | 105 | 112 | 105 |
| | | value | | | | |
| External damage | | Index | 101 | 109 | 101 | 95 |
| resistance | | value | | | | |
| | | | Comparative | Comparative | Comparative | Comparative |
| | | | Example 2 | Example 3 | Example 4 | Example 5 |
| Side | Type | — | Formulation | Formulation | Formulation | Formulation |
| rubber | | | A | E | B | B |
| layer | Thickness | mm | 1.0 | 0.5 | 0.5 | 0.5 |
| | Tensile stress | MPa | 7.02 | 4.08 | 7.02 | 7.02 |
| | of 10% | | | | | |
| Foamed | Type | — | Formulation | Formulation | Formulation | Formulation |
| rubber | | | F | F | H | I |
| layer | Thickness | mm | 1.5 | 2.0 | 2.0 | 2.0 |
| | Density | g/cm³ | 0.741 | 0.741 | 0.325 | 1.15 |
| | tan δ (20° C.) | — | 0.090 | 0.090 | 0.11 | 0.18 |
| | Thermal | W/mK | 0.185 | 0.185 | 0.115 | 0.235 |
| | Conductivity | | | | | |

| Specific gravity of | g/cm³ | 0.869 | 0.805 | 0.472 | 1.132 |
|---|---|---|---|---|---|
| sidewall portion | | | | | |
| Volume ratio (foamed | | 1.5 | 4.0 | 4.0 | 4.0 |
| rubber/side rubber) | | | | | |
| Rolling resistance | Index | 102 | 99 | 107 | 93 |
| | value | | | | |
| External damage | Index | 96 | 98 | 89 | 105 |
| resistance | value | | | | |

As is clear from Table 2, the rolling resistance of the tires of the present technology (Examples 1 to 5) is improved while maintaining and improving the external damage resistance.

In the pneumatic tires of Comparative Examples 1 to 3, since the rubber composition for sidewalls does not contain a thermoplastic resin, the external damage resistance is poor.

In the pneumatic tire of Comparative Example 4, since the density of the foamed rubber layer is less than 0.5 g/cm³, the pneumatic tire is likely to be ruptured and the external damage resistance is poor.

In the pneumatic tire of Comparative Example 5, since the tan δ at 20° C. of the foamed rubber layer exceeds 0.17, the rolling resistance is deteriorated.

1. A pneumatic tire, comprising:
a pair of left and right bead portions;
sidewall portions continuous from the bead portions; and
a tread portion that couples the sidewall portions; wherein
the pneumatic tire has a carcass layer mounted between the left and right bead portions,
in the pneumatic tire, the sidewall portions each having a foamed rubber layer disposed outside the carcass layer and a side rubber layer disposed outside the foamed rubber layer,
a density of the foamed rubber layer is from 0.5 to 0.9 g/cm³ and a tan δ of the foamed rubber layer at 20° C. is not greater than 0.17, and
a rubber composition for sidewalls that forms the side rubber layer is obtained by blending 1 to 20 parts by weight of a thermoplastic resin and 10 to 65 parts by weight of a carbon black in 100 parts by weight of a diene rubber.

2. The pneumatic tire according to claim 1, wherein the thermoplastic resin is selected from a polystyrene and a polypropylene.

3. The pneumatic tire according to claim 1, wherein a ratio of a volume of the foamed rubber layer to that of the side rubber layer (foamed rubber layer/side rubber layer) is from 1/1 to 10/1.

4. The pneumatic tire according to claim 1, wherein the rubber composition for sidewalls contains from 30 to 70 wt. % of natural rubber and from 70 to 30 wt. % of a butadiene rubber and/or a styrene butadiene rubber in 100 wt. % of the diene rubber.

5. The pneumatic tire according to claim 1, wherein the foamed rubber layer has a thermal conductivity of from 0.05 to 0.2 W/mK.

6. The pneumatic tire according to claim 1, wherein the rubber composition forming the foamed rubber layer contains a nitroso foaming agent and/or an azo foaming agent.

7. The pneumatic tire according to claim 1, wherein the rubber composition forming the foamed rubber layer contains from 0.1 to 20 parts by weight of urea in 100 parts by weight of the diene rubber.

8. The pneumatic tire according to claim 2, wherein a ratio of a volume of the foamed rubber layer to that of the side rubber layer (foamed rubber layer/side rubber layer) is from 1/1 to 10/1.

9. The pneumatic tire according to claim 8, wherein the rubber composition for sidewalls contains from 30 to 70 wt. % of natural rubber and from 70 to 30 wt. % of a butadiene rubber and/or a styrene butadiene rubber in 100 wt. % of the diene rubber.

10. The pneumatic tire according to claim 9, wherein the foamed rubber layer has a thermal conductivity of from 0.05 to 0.2 W/mK.

11. The pneumatic tire according to claim 10, wherein the rubber composition forming the foamed rubber layer contains a nitroso foaming agent and/or an azo foaming agent.

12. The pneumatic tire according to claim 11, wherein the rubber composition forming the foamed rubber layer contains from 0.1 to 20 parts by weight of urea in 100 parts by weight of the diene rubber.
